(19) United States
(12) Patent Application Publication
(10) Pub. No.: US 2026/0175245 A1
(43) Pub. Date: Jun. 25, 2026

(54) REMOTE CONTROL SYSTEM FOR NEBULIZER

(71) Applicant: GUARANY INDÚSTRIA E COMÉRCIO LTDA., Itú (BZ)

(72) Inventor: ALIDA MARIA FLEURY BELLANDI, São Paulo (BR)

(21) Appl. No.: 19/399,442

(22) Filed: Nov. 24, 2025

(30) Foreign Application Priority Data
Dec. 23, 2024 (BR) 1020240270649

(51) Int. Cl. B05B 12/08

(52) U.S. Cl. CPC B05B 12/085

(57) ABSTRACT

The present invention pertains to the technological field of machinery and equipment for combating endemics, and more specifically relates to a remote control system for a nebulizer, comprising at least one remote control for activation and operational management, interconnected with an aerosol insecticide nebulizer mounted on a platform for pickup trucks, intended for the control of pests such as mosquitoes, flies, cockroaches, and other insects. The system allows the control of the nebulizer remotely, without the operator having to travel.

### STATE OF THE ART

Controlling and combating pests is a process of great relevance to society, as it prevents the proliferation of unwanted animals that can compromise public health, cause diseases or adversely affect crops and agricultural production. To assist in this process, it is common to use nebulizer equipment, responsible for dispersing chemical agents that act in the elimination of these animals. Nebulizers allow such agents to be spread over a larger area, creating a mist composed of fine droplets, and increasing the potential for drift, spreading the product over a larger space.

In general, nebulizer equipment operates mechanically and manually, requiring the operator to travel to the equipment to turn it on and control it manually. Although this method is effective for the operation of the equipment, the operation often takes place under adverse conditions for workers, such as high temperatures, exposure to intense sun, long distances, and the constant need to travel.

To mitigate these challenges, some remote control systems for nebulizers have been developed, allowing the activation and control of the equipment remotely, in order to facilitate the process of applying the products.

The patent document CN220359990 discloses an intelligent remote-controlled pesticide spraying vehicle containing a pesticide solvent mixing box, where this mixture is directed to a nozzle to be sprayed. The movement of the vehicle and the spraying of the mixture is controlled remotely. One limitation of this type of system is that it only allows the control of one solution tank in the equipment, making it impossible for the equipment to expel different solutions/mixtures. Another drawback is that the system does not contain the management of sensors or valves that allow precise control of the flow of liquid in the equipment.

The equipment “Remote Control Station model 1800E OHV” owned by the Clarke company describes a wired remote control for controlling a nebulizer equipment. The remote control allows the equipment to be started up and contains lights to warn of the pump flow and fan status. However, this technology has the limitation of being a wired control, limiting the versatility of its use due to the necessary cabling, and, just like the previously mentioned patent document, it does not offer the possibility of simultaneous control of different reservoirs nor does it offer valve control for flow management.

The “Smartflow II” system, also owned by the Clarke company, describes a microcomputer for spraying system control. The equipment allows the activation of an electric motor/pump of a spraying system to be controlled and regulated, enabling the speed and spray flow to be altered and controlled. In addition to issuing warnings when abnormal conditions are detected. This system has wireless control, distance from the equipment, and allows the management of valves for flow control. However, a limitation of this technology is, like the other previous ones, having the control limit of only one storage tank and, in addition, it does not present possibilities for implementing a stirring or cleaning system.

These drawbacks limit the versatility of the system, making it impossible to use it in nebulizers with two or more fluid tanks.

### NOVELTIES AND OBJECTIVE OF THE INVENTION

The objective of the present invention is a remote control system for a nebulizer that effectively solves the limitations of the state of the art as referred to previously.

The control system comprises a wireless remote control interconnected via wireless communication network, to a nebulizer equipment. Said nebulizer equipment features independent hydraulic and pneumatic systems controlled by an electronic system consisting of a control box, flow, pressure, and rotation control sensors, relay, actuator, solenoid valves, and electric pump. Where all elements are directly connected to the control box and can be activated electronically.

The system control features a display that allows the verification of the equipment's operating parameters, adjustment and remote control. It allows the operator from inside the vehicle in which the equipment is being moved, to activate the nebulizer and control it, without the need to move or be exposed to environments in adverse conditions.

### Advantages and Technical Effects of the Invention

The nebulizer remote control system, object of the present invention, provides the following advantages and achieves the following technical effects over the nebulizer control systems of the state of the art:
State-of-the-art nebulizer control systems only allow the control of nebulizer equipment composed of a single storage tank, without the possibility of activating different solutions/mixtures during operation of the equipment, restricting its versatility. Solved by the present invention through a control system interconnected to a set of solenoid valves and sensors that enable the activation of different solution tanks coupled to the nebulizer equipment, being able to alternate the mode of operation according to the need; and
The nebulizer control systems of the state of the art do not have control of the stirring system of the mixtures of the remote device, requiring the operator to move to the equipment. Solved by the present invention through an electronic system with a control box directly connected to a solenoid valve responsible for the stirrer, in this way, the operator controls the mixture of the solution from the remote control.

### LIST OF ACCOMPANYING DRAWINGS

In order for this invention to be fully understood and implemented by any person skilled in this technological field, it is now described in a clear, precise, and sufficient manner, based on the accompanying drawings, listed below, which illustrate the preferred embodiments of the control system:

FIG. 1—diagram illustrating the system of the present invention;

FIG. 2—diagram illustrating the hydraulic and pneumatic connections of the nebulizer equipment;

FIG. 3—illustrates the HMI display of the invention; and

FIG. 4—illustrates the HMI display of the invention.

### DETAILED DESCRIPTION OF THE INVENTION

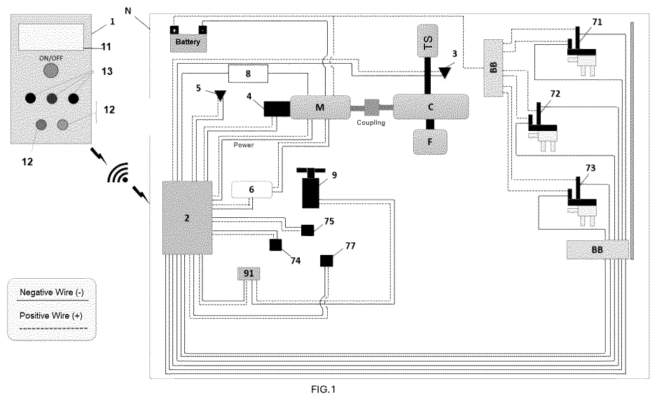

FIG. 1 illustrates the nebulizer equipment control system of the present invention, which comprises a human-machine interface-HMI (1), which can be a remote control or similar device containing wireless communication technology, such as bluetooth or the like, connected to the electronic system of a nebulizer equipment (N), preferably of the vehicle-mounted type.

Such nebulizer equipment (N) can be exemplified by the equipment disclosed in patent document BR 10 2024 017363 5, an aerosol insecticide nebulizer equipment on a platform for pickup trucks that has means of selection and/or nebulization of adulticides, larvicides or cleaning. The nebulizer comprises an autonomous air flow assembly consisting of a low-power combustion engine with a fuel tank that drives a blower for atomizing the insecticide at the atomization nozzle; a multiple reservoir set consisting of a larvicide reservoir, adulticide, and cleaning fluid mounted within a housing; a hydraulic circuit comprising a larvicide/cleaning directional valve, adulticide/cleaning, electric pump, larvicide shut-off/release valve, adulticide, return, flow control, directional, junction, and duct; Additionally, it features a stirring system comprising a stirring directional valve, tube, cap, and relief.

The HMI (1) of the invention connects directly via bluetooth with a command box (2) electronically connected to the elements that make up the nebulizer's electronic system (N) and responsible for sending the command to activate the devices. The nebulizer (N) is composed of two independent feeding systems: a pneumatic system consisting of an air blower for air flow and a hydraulic system for insecticide product flow. Via the HMI (1) the operator controls both systems simultaneously.

The HMI (1) consists of a remote control with wireless communication technology and containing an interface that allows the activation of all the electronic devices of the nebulizer, such as, for example, display (11), activation buttons (12) and navigation (13), or, it can consist of a touchscreen, controlling at least the activation of the motor (M), activation of the tanks (T1, T2 and TL) and allowing the reading of the signals sent by the sensors through a display or similar element. The first tank (T1) is responsible for larvicide storage; the second tank (T2) responsible for adulticide storage; and the cleaning tank (TL) for the cleaning fluid. Through the HMI (1), commands are sent to the control box (2) and then control signals are sent to the system elements.

The control box (2) is directly connected to at least one pressure sensor (3), the combustion engine actuator/choke (4), a flow sensor (5), a start relay (6), directional solenoid valves (71, 72 and 73), shut-off/release solenoid valves (74, 75, 77), RPM (revolutions per minute) sensor (8), and a PWM controller (91) connected to the electric motor pump (9).

In addition to the electronic sensors, the system has a mechanically actuated control valve (76).

FIG. 1 illustrates the nebulizer control system (N) and the interconnections between the devices. The HMI (1) is connected via wireless communication technology to the control box (2) directly connected to all electronic devices in the system, allowing pulses to be sent for activation and deactivation. The control box (2) is connected to a pressure sensor (3) that operates preferably in a range between 0 and 1 bar, and is physically arranged between the air compressor of the nebulizer air blower (N) and the stirring solenoid valve (71), for the detection of air pressure, informed through the HMI (1). The air blower has a combustion engine (M) connected to a starter relay (6) and an actuator/choke (4), both interconnected to the control box (2). The relay (6) receives signals from the box (2) to switch the motor (M) on and off. This box (2) sends signals to the actuator (4) so that the engine can operate, and, through the RPM sensor (8), a cable connected to the engine's ignition coil (M), receives the engine's RPM signal (M) and transmits them to the HMI (1) so that they can be viewed.

To control the hydraulic flow, the system has: directional valves (72 and 73), a flow sensor (5) and solenoid valves (74, 75 and 77) and the electric motor pump (9). All elements connected to the control box (2) and interconnected by pipes/hoses that allow the transport of the product contained in the tanks to the product outlet pipe (TS).

The flow sensor (5) is arranged next to the hose/piping connection between tanks (T1 and T2) and the product outlet pipe (TS), more precisely, between the solenoid valves (74, 75 and 77) and the product outlet pipe (TS). The sensor (5) sends hydraulic flow detection and volume signals to the control box (2), which transmits them to the HMI (1). The sensor (5) operates, preferably, in a range between 50 ml/min and 3,800 ml/min and is responsible for sending a signal to the box (2) when the chemical product in the tank runs out, issuing the warning along with the HMI (1) to the operator.

In conjunction with the flow sensor (5), to control the hydraulic power, the system has directional solenoid valves (72) and (73) connected to the outlet pipe of the first tank (T1) and second tank (T2), respectively. These valves (72 and 73) allow you to direct whether the chemicals will be transported to the cleaning tank (TL) or to the product outlet pipe (TS). The control box (2) sends signals for opening and closing the valves from controls operated on the HMI (1).

Further, the system has four other valves, being the block solenoid valve (74) of the tank (T1), block solenoid valve (75) of the tank (T2), mechanical flow control valve (76) of the tank (T2), and block solenoid valve (77) of the tank return (T2). The four valves (74, 75, 76 and 77) are arranged between the electric motor pump (9) and the product outlet pipe (TS). The shut-off valve (74) of the tank (T1) controls the product output from the tank (T1) after it has passed through the electric motor pump (9). Similarly, the valves (75, 76 and 77) control the exit of the product from the tank (T2) after passing through the electric motor pump (9), however, after passing through the valve (75) the flow has two paths, part of the product is directed to the control valve (76), regulating the flow of the product and directing it to the product outlet pipe (TS), and another part is directed to the valve (77) that allows the return of the product to the tank (T2) if activated by the operator.

The mechanical control valve (76) is of the needle type and regulates the passage of liquid to the nozzle, coming only from the tank (T2). Manual actuation of the needle selector allows for release (counterclockwise turning) or closing (clockwise turning) of the liquid passage.

The electronic system has connection terminals (BB) exemplified in FIG. 1 by terminal bars, to assist in the connection between the wires and the circuit devices.

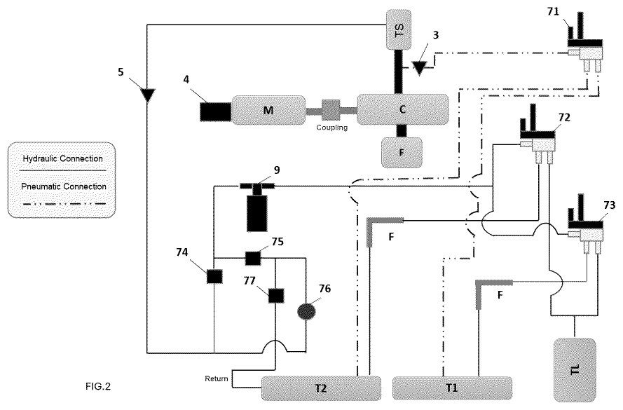

FIG. 2 illustrates the hydraulic and pneumatic power systems present in a nebulizer equipment.

In the hydraulic system there are three tanks, the first tank (T1), the second tank (T2), cleaning tank (TL) and filters (F) all connected to each other through pipes/hoses for the flow of insecticide products. The flow is moved by the electric motor pump (9) and directed to the product outlet pipe (TS) of the nebulizer (N) to be expelled. This entire system is managed by the HMI (1), through the solenoid valves (72), (73), (74), (75) and (77), control valve (76) and the flow sensor (5).

This electric motor pump (9) is directly connected to a PWM controller (91) which allows you to control the speed or power of the motor pump by adjusting the amount of energy supplied to the motor.

The arrangement of solenoid valves (74, 75 and 77), avoids the mixing of chemicals in the hydraulic power system, in this way, the solenoid valves cannot be activated simultaneously, ensuring that the products in the pipes or in the tank are not contaminated.

The pneumatic system is composed of the first tank (T1), the second tank (T2), combustion engine (M) coupled to the compressor (C) and filter (F).

The pneumatic system works as follows: the combustion engine (M) is activated through the relay (6) and used to drive the air compressor (C) generating compressed air. Such compressed air is directed to the product outlet pipe (TS), and can be directed in part to stirring the mixtures in the tanks (T1), (T2), or expelled entirely through the product outlet pipe (TS). The part of the compressed air flow directed to the stirring of the products in the tanks is controlled via the stirring solenoid valve (71), a three-way valve, by which it is determined whether the product in the tank (T1) or (T2) will be moved. The portion of the compressed air flow that is directed to the product outlet pipe (TS) will be mixed with the product originating from the hydraulic system, and ejected at the desired location. The control system manages the pneumatic power through the stirring solenoid (71), pressure sensor (3), actuator (4) and relay (6).

The entire system is powered by nebulizer equipment batteries (N); however, it can be powered via cable by a power distribution network. Preferably, the system operates at a voltage of 12V, but it is not limited to this.

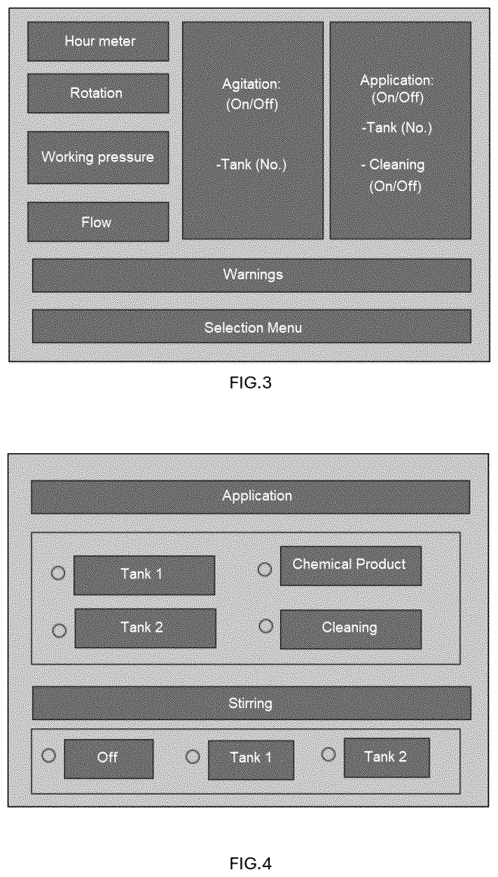

In FIG. 3, the operation of the system is illustrated through the display (11) of the HMI (1), exemplifying operating options presented by the control system of the present invention. Through the system it is possible for the operator to check the parameters and operation and the mode of operation of the nebulizer (N). The Display (11) shows which tank is being used by the operator at the time of application, the nebulizer operating mode (N), indicates whether the options for stirring or cleaning the tanks are activated, the usage time and shows information about the operation performed, such as engine speed (M), air pressure and product flow. In addition, the HMI (1) displays warnings according to the signals sent by the sensors.

The layout of the display (11) is programmable, so the menus and options can be changed according to the user's need.

Warnings are programmed next to the nebulizer control box (2), for example, when the flow sensor (3) detects that it is not being transported through the pipes/hoses, the display (11) exhibits a chemical shortage warning.

Said HMI (1) can also present on its display (11) a “selection menu,” illustrated in FIG. 4, which shows the operating options for the nebulizer equipment (N). The operator can select the elements to be used for the operation.

In this way, the invention system allows the operator to have total control over the nebulizer (N) even remotely, being able to use different insecticide products according to the need, and perform equipment maintenance, such as stirring of the tanks and cleaning.

The information selected in the HMI (1) is sent directly to the control box (2) of the nebulizer and then the activation signals are sent to the electronic devices.

What is claimed is:

1. A REMOTE CONTROL SYSTEM FOR A NEBULIZER connected to the nebulizer (N) comprising a hydraulic system for product flow and a pneumatic system comprising an air blower containing a combustion engine (M) coupled to a compressor (C) for the flow of compressed air, the control system comprising an HMI (1) connected directly via wireless communication to a control box (2) of the nebulizer (N) electronically interconnected to:
a pressure sensor (3) arranged between the air compressor (C) of the nebulizer (N) and a stirring solenoid valve (71), for detecting air pressure, reported through the HMI (1);
an actuator or choke (4) connected to the combustion engine (M); wherein, said control box (2) receives from the actuator (4) operating parameters of the engine;
a start relay (6) connected to the combustion engine (M); wherein, through signals emitted by the control box (2), the relay (6) is activated to start and stop the engine (M);
a RPM sensor (8) that sends a RPM signal from the engine (M) to the box (2);
a flow sensor (5), connected to a connecting hose or pipe between tanks (T1) (T2) and a product outlet pipe (TS) of the nebulizer (N), sending detection signals and volume of hydraulic flow to the control box (2);
directional solenoid valves (72) and (73) connected to the outlet pipe of the first tank (T1) and the second tank (T2), respectively;
a shut-off solenoid valve (74) of the tank (T1) connected to the connecting hose or pipe between an electric pump (9) and the product outlet pipe (TS);
a shut-off solenoid valve (75) of the tank (T2) connected to the connecting hose or pipe between the electric pump (9) and the product outlet pipe (TS);
a mechanical control valve (76) of the tank (T2) connected to the connecting hose or pipe between the electric pump (9) and the product outlet pipe (TS);
a return shut-off solenoid valve (77) of the tank (T2) connected to the connecting hose [/] or pipe between the electric pump (9) and the product outlet pipe (TS); and
the electric pump (9) being connected to the connecting hose or pipe between the tanks (T1 and T2) and the product outlet pipe (TS).

2. The SYSTEM of claim 1, wherein the HMI (1) comprises a remote control containing display (11), activation buttons (12), and navigation buttons (13).

3. The SYSTEM of claim 2, wherein the display (11) comprises a touchscreen.

4. The SYSTEM of claim 1, wherein the control box (2) connected to a PWM controller (91) connected to the electric pump (9).
